(19) United States
(12) Patent Application Publication
(10) Pub. No.: US 2025/0274743 A1
(43) Pub. Date: Aug. 28, 2025

(54) METHOD, APPARATUS AND SYSTEM FOR CONFIGURING UNMANNED AERIAL VEHICLE, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/858,488

(22) PCT Filed: Apr. 25, 2022
(86) PCT No.: PCT/CN2022/089089

§ 371 Date: Oct. 21, 2024

(51) Int. Cl. H04W 8/24; B64U 70/90

(52) U.S. Cl. CPC H04W 8/24; B64U 70/90; B64U 2201/20

(57) ABSTRACT

A method for configuring an unmanned aerial vehicle (UAV) is performed by the UAV and includes: sending equipment information of the UAV to a base station, where the equipment information includes an equipment type of the UAV; and receiving first information sent by the base station based on the equipment information, where the first information is used for configuring the UAV.

### CROSS-REFERENCE TO RELATED APPLICATIONS

This application is a U.S. National Stage of International Application No. PCT/CN2022/089089, filed on Apr. 25, 2022, which is incorporated by reference herein in its entirety for all purposes.

### TECHNICAL FIELD

This application relates to the field of communications, and in particular to a method, an apparatus, a system and a storage medium for configuring an unmanned aerial vehicle (UAV).

### BACKGROUND

UAV is an unmanned aircraft controlled by a radio remote control device and its own program control device. With the rapid development of UAV technology, the cost of UAVs is reduced and their functions are improved, UAVs can be used by different industries, different fields and different groups of people.

The use of UAVs is often controlled and regulated. For example, the use of UAVs may be prohibited in no-fly zones; the use of only small UAVs may be allowed in densely populated urban areas while the use of large UAVs is prohibited. Controlling and managing the UAV requires configuring the UAV. For example, the UAV is configured to report information required for control or management.

Currently, users can use point-to-point communication to configure UAVs, but the communication distance of point-to-point communication is short and UAVs can only be configured at close range. This configuration method bas low efficiency and flexibility.

### SUMMARY

Embodiments of this disclosure provide a method, an apparatus, a system and a storage medium for configuring a UAV. The technical solutions are as follows.

According to an aspect of embodiments of this disclosure, there is provided a method for configuring a UAV, which is performed by the UAV and includes:

sending equipment information of the UAV to a base station, where the equipment information includes an equipment type of the UAV; and

receiving first information sent by the base station based on the equipment information, where the first information is used for configuring the UAV.

According to another aspect of embodiments of this disclosure, there is provided a method for configuring a UAV, which is performed by a base station and includes: receiving equipment information of the UAV, where the equipment information includes an equipment type of the UAV; and sending first information to the UAV based on the equipment information, where the first information is used for configuring the UAV.

According to another aspect of the embodiments of this disclosure, a UAV is provided and includes:
a processor; and
a transceiver coupled to the processor;
where the processor is configured to execute executable instructions, thereby implementing the method for configuring the UAV according to any aspect described above.

According to another aspect of the embodiments of this disclosure, a base station is provided and includes:
a processor; and
a transceiver coupled to the processor;
where the processor is configured to execute executable instructions, thereby implementing the method for configuring the UAV according to any aspect described above.

It should be understood that the foregoing general description and the following detailed description are exemplary and explanatory only, and do not limit this disclosure.

### BRIEF DESCRIPTION OF THE DRAWINGS

In order to more clearly illustrate the technical solutions in the embodiments of the present application, the drawings to be used in the description of the embodiments will be briefly introduced below. Obviously, the drawings in the following description are only some embodiments of the present application. For those of ordinary skill in the art, other drawings can also be obtained based on these drawings without exerting creative efforts.

FIG. 1 is a schematic diagram of a communication system according to an exemplary embodiment.

FIG. 2 is a schematic diagram of a communication system according to another exemplary embodiment.

FIG. 3 is a flow chart of a method for configuring a UAV according to an exemplary embodiment.

FIG. 4 is a schematic diagram of first information according to an exemplary embodiment.

FIG. 5 is a flowchart of a method for configuring a UAV according to another exemplary embodiment.

FIG. 6 is a flow chart of a method for configuring a UAV according to another exemplary embodiment.

FIG. 7 is a flow chart of a method for configuring a UAV according to another exemplary embodiment.

FIG. 8 is a flowchart of a method for configuring a UAV according to another exemplary embodiment.

FIG. 9 is a flow chart of a method for configuring a UAV according to another exemplary embodiment.

FIG. 10 is a flow chart of a method for configuring a UAV according to another exemplary embodiment.

FIG. 11 is a schematic diagram of first information according to another exemplary embodiment.

FIG. 12 is a flowchart of a method for configuring a UAV according to another exemplary embodiment.

FIG. 13 is a block diagram of an apparatus for configuring a UAV according to an exemplary embodiment.

FIG. 14 is a block diagram of an apparatus for configuring a UAV according to another exemplary embodiment.

FIG. 15 is a schematic structural diagram of a UAV according to an exemplary embodiment,

FIG. 16 is a schematic structural diagram of a base station according to an exemplary embodiment.

### DETAILED DESCRIPTION

Exemplary embodiments will be described in detail herein, examples of which are illustrated in the accompanying drawings. When the following description refers to the drawings, the same numbers in different drawings refer to the same or similar elements unless otherwise indicated. The implementations described in the following exemplary embodiments, do not represent all implementations consistent with this disclosure. Rather, they are merely examples of apparatuses and methods consistent with aspects of the disclosure as detailed in the appended claims.

UAV is an unmanned aircraft that can be controlled by a radio remote control device. UAV is the abbreviation of unmanned aerial vehicle. From a technical perspective, UAVs can be divided into several types: unmanned fixed-wing aircraft, unmanned vertical take-off and landing aircraft, unmanned airships, unmanned helicopters, unmanned multi-rotor aircraft and unmanned paragliders. From the perspective of UAV size, UAVs can be divided into several types such as micro UAVs, light UAVs, small UAVs, medium UAVs and large UAVs.

With the rapid development of UAV technology, the cost of UAVs is reduced and the functions of UAVs are becoming more and more perfect, making the fields of UAV applications wider and wider. “UAV+industrial applications” are the mainstream of UAV applications. UAVs are currently widely used in fields such as aerial photography, agriculture, plant protection, micro-selfies, express transportation, news reporting, power inspections, and film and television shooting.

The use of UAVs is often controlled and/or managed. For example, for different types of UAVs and/or UAVs in different application fields, the flying height of the UAV, the area where the UAV is allowed to fly, the time period when the UAV is allowed to fly, and/or other factors such as weather conditions under which the UAV is allowed to fly are managed and/or controlled differently. In order to efficiently control and/or manage the UAV, the UAV can be connected to a cellular communication network. Due to the wide coverage of the cellular communication network, the cellular communication network can be used to control and/or manage the UAV efficiently and flexibly.

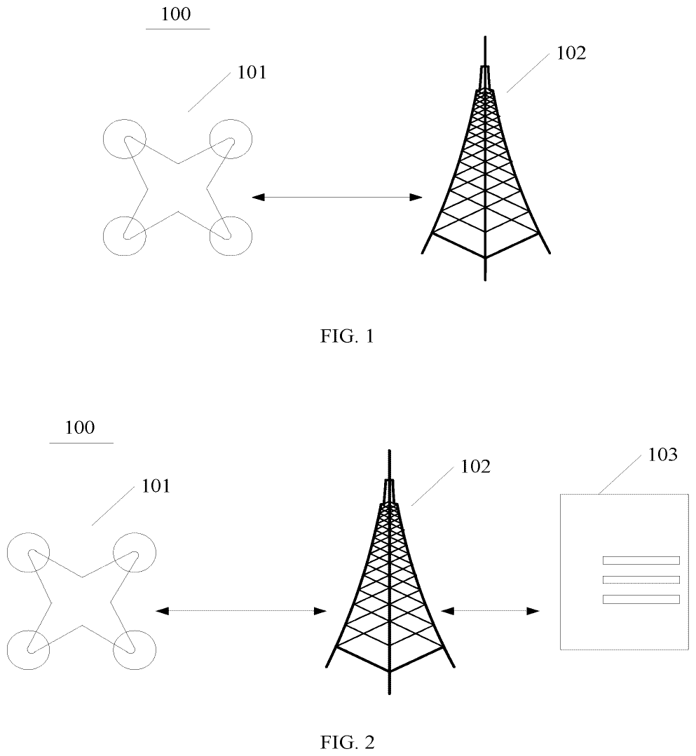

FIG. 1 shows a block diagram of a communication system 100 according to an exemplary embodiment of this disclosure. The communication system 100 includes a UAV 101 and a base station 102, and communication can be performed between the UAV 101 and the base station 102.

Both the UAV 101 and the base station 102 are connected to the cellular communication network. Optionally, a communication connection is established between the UAV 101 and the base station 102 in the cellular communication network to realize the communication between the UAV 101 and the base station 102. Alternatively, there may be other ways to realize the communication between the UAV 101 and the base station 102, which are not elaborated here.

Optionally, the communication connection established between the UAV 101 and the base station 102 includes a wireless connection and the like.

Optionally, the UAV 101 is a UAV with cellular communication function. After the UAV 101 is powered on, it can select a base station 102 from at least one base station 102 covering the UAV 101 and access the selected base station 102. The at least one base station 102 includes a base station(s) in the cellular communication network, so that the UAV 101 can access the cellular communication network.

Herein, the cellular communication network where the UAV 101 and the base station 102 are located may be the fifth generation mobile communication technology (SG) network, or the long term evolution (LTE) network, or other cellular communication networks similar to the LTE network or the 5G network.

Due to the wide coverage of the cellular communication network, configuration of the UAV 101 through the cellular communication network is not limited by distance, and the UAV 101 can be configured anytime and anywhere, thereby improving the flexibility and efficiency of configuring the UAV 101.

For solutions of configuring the UAV 101 by using a point-to-point communication, the communication distance of the point-to-point communication manner is generally shorter. For example, a common point-to-point communication manner is wireless fidelity (wifi) communication, and the distance of wifi communication is typically only tens or hundreds of meters. Therefore, the UAV 101 can only be configured after approaching the UAV 101 at a close distance. The efficiency and flexibility of configuring the UAV 101 are far inferior to the solution of configuring the UAV 101 through the cellular communication network according to the embodiments of this disclosure.

Optionally, for the UAV 101 accessing the base station 102, the base station 102 can perform configuration for the UAV 101, thereby configuring the UAV 101 to send the information required for operations such as controlling and/or managing the UAV 101.

For example, the UAV 101 can send equipment information of the UAV 101 to the base station 102. The base station 102 can configure, based on the equipment information, which type(s) of identity information the UAV 101 is to send. For the identity information that is to be sent, the base station 102 can also configure a sending manner and/or contents such as a sending condition for sending the identity information by the UAV 101, and/or, the base station 102 can configure a take-off condition(s) under which the UAV 101 can take off.

Optionally, the UAV 101 may be a UAV with the function of remotely reporting identity information. In other words, the UAV 101 can directly and remotely report the identity information of the UAV 101. The so-called remote reporting of identity information means that the UAV can report the identity information remotely by using the cellular communication network.

Alternatively, the UAV 101 may be a UAV that reports identity information through a remote reporting module. The remote reporting module does not belong to the UAV 101, and is used to remotely report the identity information of the UAV. The UAV 101 is connected to the remote reporting module, so that the UAV 101 can remotely report the identity information of the UAV 101 through the remote reporting module.

Alternatively, the UAV 101 may be a UAV that cannot remotely report identity information. In other words, the UAV 101 does not have the function of remotely reporting identity information, nor is it connected to a remote reporting module for remotely reporting identity information.

Optionally, referring to FIG. 2, the communication system 100 further includes a control device 103 that communicates with the base station 102. The control device 103 can communicate with the UAV 101 through the base station 102, thereby controlling and/or managing the UAV 101.

Optionally, the control device 103 may be a console corresponding to the UAV 101, a handle device with the function of controlling and/or managing the UAV 101, a terminal device with the function of controlling and/or managing the UAV 101, or the like.

Next, the configuration process of the UAV 101 will be described through any of the following embodiments. For details, any of the embodiments described below can be referred to.

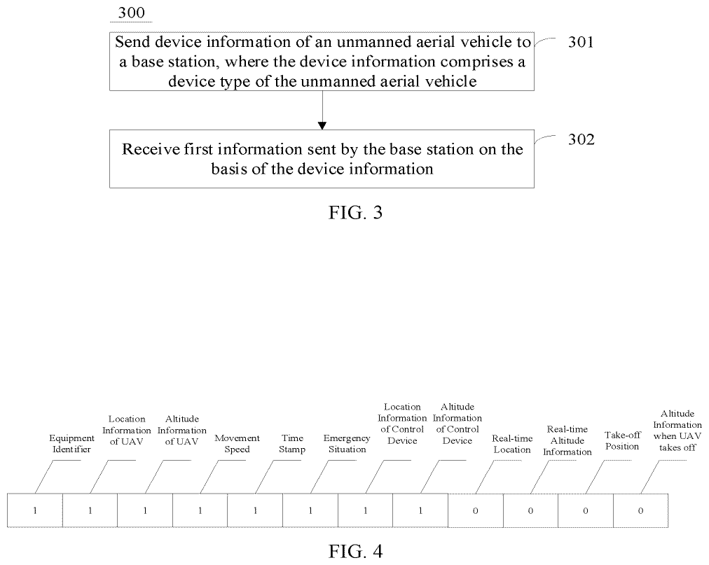

FIG. 3 shows a flow chart of a method 300 for configuring a UAV according to an exemplary embodiment of this disclosure, which is applied in the communication system 100 shown in FIG. 1 or FIG. 2. The method 300 is performed by the UAV and includes following steps.

In step 301, equipment information of the UAV is sent to a base station, where the equipment information includes an equipment type of the UAV.

Optionally, the equipment information of the UAV further includes at least one of the following: an equipment group to which the UAV belongs, an application field to which the UAV is applied, or the like.

The UAV can send the equipment information of the UAV to the base station, thereby informing the base station of the equipment group to which the UAV belongs. UAVs belonging to the same enterprise can be combined into an equipment group, or UA Vs belonging to the same user group can be combined into an equipment group, or the like. Thus, the base station can uniformly configure the equipment group to which the UAVs belong, thereby making the management easier.

The UAV can also send the equipment information of the UAV to the base station, thereby informing the base station of the application field of the UAV. The application fields of the UAV may include film and television shooting, news reporting, or the like. Therefore, the base station can perform a targeted configuration for the application field of the UAV.

In addition, the UAV can also send the equipment information of the UAV to the base station, thereby informing the base station of the equipment type of the UAV. In some embodiments, the equipment types of the UAV include at least the following: a UAV with the function of remotely reporting identity information; a UAV that reports identity information through a remote reporting module which does not belong to the UAV; a UAV that cannot report identity information remotely; and the like.

For UAVs with different equipment information, the base station is to configure the UAVs differently. For example, for UAVs with different equipment types, the identity information to be reported by the UAVs is differently configured by the base station. For another example, for UAVs in different equipment groups, the identity information to be reported by the UAVs is differently configured by the base station.

Optionally, the UAV may send the equipment information of the UAV to the base station under the following circumstances, so that the base station can configure the UAV based on the equipment information. These circumstances include the followings. After the UAV accesses the base station, the UAV sends the equipment information of the UAV to the base station. Optionally, during the movement of the UAV, the UAV leaves an coverage area of a connected base station and chooses to access a new base station, the equipment information of the UAV is sent to the new base station. Optionally, the UAV periodically sends the equipment information of the UAV to the base station. Optionally, the UAV sends the equipment information of the UAV to the base station upon being triggered by the base station. Alternatively, there may be other circumstances that cause the UAV to send the equipment information of the UAV to the base station, which will not be elaborated here.

In step 301, the UAV may send a first signaling to the base station. The first signaling includes a first information element (IE), and the first IE includes the equipment information of the UAV.

Exemplarily, the first signaling is a first radio resource control (RRC) signaling, and the first IE includes at least one of the following: user equipment-evolved universal terrestrial radio access network-capability (UE-EUTRA-Capability) in the first RRC signaling;
user equipment-Multi-RAT dual connectivity-capability (UE-MRDC-Capability) in the first RRC signaling;
user equipment-new radio-capability (UE-NR-Capability) in the first RRC signaling; or the like.

In other words, the UAV sends the first RRC signaling to the base station, and the UE-EUTRA-Capability, UE-MRDC-Capability and/or UE-NR-Capability in the first RRC signaling includes the equipment information of the UAV.

In step 302, first information sent by the base station based on the equipment information is received.

Optionally, the first information is used for configuring the UAV. Exemplarily, several examples in which the first information is used for configuring the UAV are listed below, including Example 1 and Example 2 respectively.

In Example 1, the first information is used for configuring at least one type of identity information that the UAV is to send, and the at least one type of identity information corresponds to the equipment information of the UAV.

Optionally, the UAV determines the at least one type of identity information that is to be sent based on the first information.

Optionally, the at least one type of identity information corresponds to the equipment type of the UAV.

For example, the equipment type of the UAV is a UAV with the function of remotely reporting identity information, the at least one type of identity information includes at least one of the following:
an equipment identifier of the UAV;
location information of the UAV;
altitude information of the UAV;
a movement speed of the UAV;
a time stamp of the UAV;
an emergency situation occurred at the UAV;
location information of a control device or altitude information of the control device, where the control device is a device configured to control the UAV; or the like.

For another example, the equipment type of the UAV is a UAV that reports identity information through a remote reporting module, where the remote reporting module does not belong to the UAV. The at least one type of identity information includes at least one of the following:
an equipment identifier of the UAV;
a real-time location of the UAV;
real-time altitude information of the UAV;
a movement speed of the UAV;
a take-off position of the UAV;
altitude information when the UAV takes off; or
a time stamp of the UAV; or the like.

Optionally, in the case of Example 1, the first information may be the following types of information.

As to Type a, the first information includes information identifier of each identity information type in the at least one type of identity information.

For any one of the at least one type of identity information, the information identifier of the identity information includes one or more of the following: a category of the identity information, a name of the identity information, a serial number of the identity information, or the like.

Optionally, the operation of the UAV determining the at least one type of identity information is that, the UAV determines the at least one type of identity information that is to be sent based on the information identifier(s) of the at least one type of identity information included in the first information.

As to Type b, the first information includes first identification information, and the first identification information is indicative of the at least one type of identity information.

Optionally, the UAV stores a correspondence between identity information sets and identification information. For any item in the correspondence, it includes an identity information set and identification information corresponding to the identity information set, where the identity information set includes at least one type of identity information.

Optionally, the operation of the UAV determining the at least one type of identity information is that, the UAV obtains, based on the first identification information included in the first information, a corresponding first identity information set from the correspondence between the identity information sets and the identification information, where the first identity information set includes at least one type of identity information.

Optionally, the base station may also store the correspondence between the identity information sets and the identification information. In the correspondence between the identity information sets and the identification information stored in the base station, there are items including the first identity information set and the first identification information.

For example, the UAV and the base station agree in advance on the correspondence between the identity information sets and the identification information, and respectively store the agreed correspondence between the identity information sets and the identification information. Alternatively, a third-party device configures the correspondence between the identity information sets and the identification information on the UAV and the base station, respectively. Optionally, the third-party device includes the control device corresponding to the UAV, or the like. Alternatively, a standard used by both the UAV and the base station defines the correspondence between the identity information sets and the identification information, and both the UAV and the base station can obtain and save the correspondence between the identity information sets and the identification information based on this standard.

For example, referring to the correspondence between the identity information sets and the identification information shown in Table 1 below, both the UAV and the base station store the correspondence between the identity information sets and the identification information as shown in Table 1. Assuming that the first identification information included in the first information is “1”, based on the first identification information “1”, the UAV obtains a corresponding first identity information set from the correspondence between the identity information sets and the identification information as shown in Table 1. The first identity information set includes the equipment identifier of the UAV, the location information of the UAV, the altitude information of the UAV, the movement speed of the UAV, the time stamp of the UAV, the emergency state occurred at the UAV, and the location information of the control device or the altitude information of the control device.

TABLE 1

| | Identification |
|---|---|
| Identity Information Set | Information |
| equipment identifier of UAV, location information | 1 |
| of UAV, altitude information of UAV, movement speed | |
| of UAV, time stamp of UAV, emergency state occurred | |
| at UAV, location information of control device | |
| or altitude information of control device | |
| equipment identifier of UAV, real-time location of UAV, | 2 |
| real-time altitude information of UAV, movement speed | |
| of UAV, take-off position of UAV, altitude information | |
| when UAV takes off, or time stamp of UAV | |
| . . . | . . . |

As to Type c, the first information includes a plurality of bits, with each identity information type in the at least one type of identity information in the first information corresponding to different bits, and a bit value corresponding to each identity information type is a first value.

Optionally, the operation of the UAV determining the at least one type of identity information is that, the UAV identifies at least one bit with the first value in the first information, and determines the at least one type of identity information corresponding to at least one bit.

For example, referring to FIG. 4, the first information includes twelve bits. In the first information, the identity information corresponding to the first bit is the equipment identifier of the UAV, the identity information corresponding to the second bit is the location information of the UAV, the identity information corresponding to the third bit is the altitude information of the UAV, the identity information corresponding to the fourth bit is the movement speed of the UAV, the identity information corresponding to the fifth bit is the time stamp of the UAV, the identity information corresponding to the sixth bit is the emergency state occurred at the UAV, the identity information corresponding to the seventh bit is the location information of the control device, the identity information corresponding to the eighth bit is the altitude information of the control device, the identity information corresponding to the ninth bit is the real-time location of the UAV, the identity information corresponding to the tenth bit is the real-time altitude information of the UAV, the identity information corresponding to the eleventh bit is the take-off position of the UAV, and the identity information corresponding to the twelfth bit is the altitude information of the UAV when it takes off.

Referring to FIG. 4, assuming that values of the first bit, the second bit, the third bit, the fourth bit, the fifth bit, the sixth bit, the seventh bit and the eighth bit in the first information are all the first value “1”, and values of the ninth bit, the tenth bit, the eleventh bit and the twelfth bit are all the second value “0”.

After receiving the first information as shown in FIG. 4, the UAV identifies the first bit, the second bit, the third bit, the fourth bit, the fifth bit, the sixth bit, the seventh bit and the eighth bit whose value is the first value “1” from the first information, and determines, based on the eight bits, eight types of identity information corresponding to the eight bits. The eight types of identity information are respectively the equipment identifier of the UAV, the location information of the UAV, the altitude information of the UAV, the movement speed of the UAV, the time stamp of the UAV, the emergency state occurred at the UAV, the location information of the control device, and the altitude information of the control device.

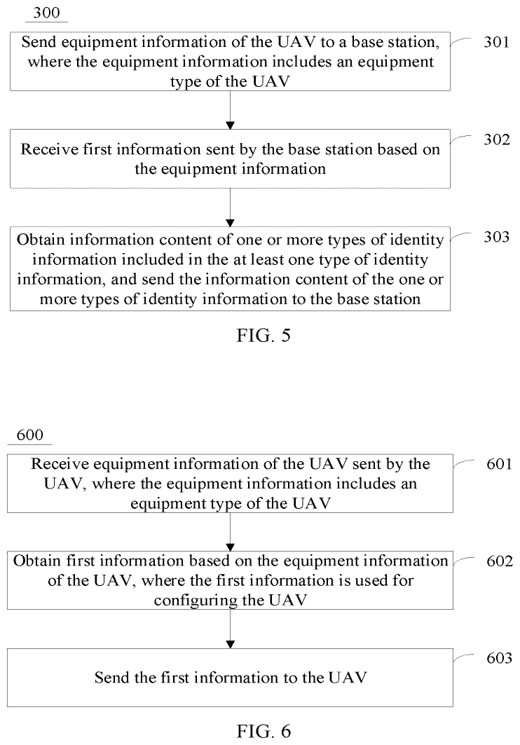

Optionally, referring to FIG. 5, after determining the at least one type of identity information, the UAV may further perform the following operation 303: obtaining information content of one or more types of identity information included in the at least one type of identity information, and sending the information content of the one or more types of identity information to the base station.

Optionally, the UAV sends the information content of the at least one type of identity information to the base station in a broadcast manner.

For example, assuming that the at least one type of identity information includes the altitude information of the UAV, the altitude information currently obtained by the UAV is “100 meters”, and the information content of the altitude information sent to the base station is “100 meters”. For another example, assuming that the at least one type of identity information includes the movement speed of the UAV, the current movement speed obtained by the UAV is “50 m/s”, and the information content of the movement speed sent to the base station is “50 m/s”.

Optionally, the at least one type of identity information includes first identity information, and the first information is used for configuring a sending manner of the UAV to send the first identity information, and/or the first information is used for configuring a sending condition of the UAV to send the first identity information.

Optionally, the sending manner of the first identity information includes a broadcast manner of the first identity information. In this way, when the UAV obtains the information content of the first identity information, it broadcasts the information content of the first identity information to the base station based on the broadcast manner of the first identity information.

Optionally, the broadcast manner may be periodic broadcast or real-time broadcast. For example, when the first identity information is the equipment identifier of the UAV, the sending manner of the first identity information may include periodically broadcasting the equipment identifier of the UAV. For another example, the first identity information is the location information of the UAV, and the sending manner of the first identity information may include broadcasting the location information of the UAV in real time.

Optionally, regarding the sending condition of the first identity information, when the UAV obtains the information content of the first identity information and the sending condition is met, it broadcasts the information content of the first identity information to the base station.

For example, assuming that the first identity information is the movement speed of the UAV, and the sending condition of the first identity information is to send it when the movement speed exceeds a specified threshold. In this way, when the UAV obtains its own movement speed, if the movement speed exceeds the specified threshold, the movement speed of the UAV will be broadcast to the base station.

In Example 2, the first information is used for configuring a take-off condition(s) for the UAV to take off.

Optionally, the UAV determines, based on the first information, the take-off condition(s) under which the UAV can take off.

Optionally, the take-off condition includes an area in which the UAV can take off, and/or a time period in which the UAV can take off, and the like.

For example, the first information includes area information of the area in which the UAV can take off, and/or time information of the time period in which the UAV can take off. The area information may be an area name, an area number, or the like. The time information may be the starting time and ending time of the time period, or the starting time and duration of the time period, or the ending time and duration of the time period.

Optionally, when the equipment type of the UAV is a UAV that cannot remotely report identity information, the first information sent by the base station may be used for configuring the take-off condition of the UAV.

Optionally, the take-off condition includes an area where the UAV can take off, which is an area where the UAV is allowed to take off. Since the UAV cannot report identity information remotely, the UAV can take off in this area without reporting the identity information of the UAV remotely.

Optionally, in step 302, the UAV receives a second signaling sent by the base station, where the second signaling includes a second IE, and the second IE includes the first information.

Optionally, the second signaling includes a second RRC signaling, and the second IE includes other configuration (OtherConfig) in the second RRC signaling. In other words, the UAV receives the second RRC signaling sent by the base station, and the OtherConfig in the second RRC signaling includes the first information.

Optionally, the second signaling includes an RRC reconfiguration signaling (RRCReconfiguration), an RRC connection reconfiguration signaling (RRCConnectionReconfiguration), or the like.

Optionally, the UAV may perform the process according to some embodiments of this disclosure upon being triggered by the base station. In other words, in step 301, the UAV sends the equipment information of the UAV to the base station when triggered by the base station. Before performing step 301, the UAV may receive an inquiry instruction sent by the base station, where the inquiry instruction is used for instructing the UAV to send the equipment information of the UAV. Based on the inquiry instruction, the UAV sends the equipment information of the UAV to the base station.

Optionally, the UAV receives a third signaling sent by the base station, where the third signaling includes a third IE, and the third IE includes the inquiry instruction.

Optionally, the third signaling includes a third RRC signaling and the like, and the third IE includes UECapabilityEnquiry in the third RRC signaling. In other words, the UAV receives the third RRC signaling sent by the base station, and the UECapabilityEnquiry in the third RRC signaling includes the inquiry instruction.

To sum up, based on the method for configuring a UAV according to some embodiments of this disclosure, the UAV sends the equipment information of the UAV to the base station, and the equipment information includes the equipment type of the UAV; then the UAV receives the first information sent by the base station based on the equipment information, where the first information is used for configuring at least one type of identity information that the UAV is to send. In this way, the problem of the UAV reporting corresponding identity information based on its own equipment information can be solved. The first information is used for configuring the sending manner and/or sending condition of the identity information, thereby solving the problem that the UAV can send the identity information according to the requirements of the base station. The first information is used for configuring the take-off condition for the UAV to take off, thereby solving the problem that the UAV can take off according to the requirements of the base station. Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

FIG. 6 shows a flow chart of a method 600 for configuring a UAV according to an exemplary embodiment of this disclosure. The method 600 is applied in the communication system 100 shown in FIG. 1 or FIG. 2 and is performed by a base station. The method 600 includes the followings.

In step 601, equipment information of the UAV sent by the UAV is received, where the equipment information includes an equipment type of the UAV.

Optionally, the equipment information of the UAV further includes at least one of the following: an equipment group to which the UAV belongs, an application field to which the UAV is applied, or the like.

Optionally, the base station receives a first signaling sent by the UAV, where the first signaling includes a first IE, and the first IE includes the equipment information of the UAV.

Exemplarily, the first signaling is a first RRC signaling, and the first IE includes at least one of the following:
UE-EUTRA-Capability in the first RRC signaling;
UE-MRDC-Capability in the first RRC signaling; or,
UE-NR-Capability in the first RRC signaling; or the like.

In other words, the base station receives the first RRC signaling sent by the UAV, and UE-EUTRA-Capability, UE-MRDC-Capability and/or UE-NR-Capability in the first RRC signaling includes the equipment information of the UAV.

Optionally, before receiving the equipment information of the UAV, the base station may also instruct the UAV to send the equipment information of the UAV when the method is implemented.

Before performing step 601, the base station sends an inquiry instruction to the UAV, where the inquiry instruction is used for instructing the UAV to send the equipment information of the UAV.

Optionally, the base station sends a third signaling to the UAV, where the third signaling includes a third IE, and the third IE includes the inquiry instruction.

Optionally, the third signaling includes a third RRC signaling and the like, and the third IE includes UECapabilityEnquiry in the third RRC signaling. In other words, the base station sends the third RRC signaling to the UAV, and UECapabilityEnquiry in the third RRC signaling includes the inquiry instruction.

In step 602, first information is obtained based on the equipment information of the UAV, where the first information is used for configuring the UAV.

Optionally, the first information is used for configuring the UAV. Exemplarily, two examples in which the first information is used for configuring the UAV are listed below.

In Example 1, the first information is used for configuring at least one type of identity information that the UAV is to send.

In Example 1, the base station determines, based on the equipment information of the UAV, at least one type of identity information that the UAV is to send, and obtains the first information for configuring the at least one type of identity information.

Optionally, the base station stores a correspondence between equipment information of UAV and identity information sets. For any item in the correspondence, it includes a piece of UAV equipment information and an identity information set, where the identity information set includes at least one type of identity information that the UAV is to send.

Optionally, the operation of the base station determining the at least one type of identity information may be that, based on the equipment information of the UAV, the base station obtains a corresponding identity information set from the correspondence between the equipment information of UAV and the identity information sets, where the corresponding identity information set includes the at least one type of identity information that the UAV is to send.

Optionally, the correspondence between the equipment information of UAV and the identity information sets includes a correspondence between equipment types of UAV and identity information sets.

For example, referring to the correspondence between the equipment information of UAV and the identity information sets shown in Table 2 below, it is assumed that the equipment type included in the equipment information of the UAV received by the base station is a UAV with the function of remotely reporting identity information. Based on the equipment information of the UAV (a UAV with the function of remotely reporting identity information), the base station obtains a corresponding first identity information set from the correspondence between the equipment information of UAV and the identity information sets as shown in Table 2. The first identity information set includes 8 types of identity information that the UAV is to send, which are respectively the equipment identifier of the UAV, the location information of the UAV, the altitude information of the UAV, the movement speed of the UAV, the time stamp of the UAV, the emergency state occurred at the UAV, and the location information of the control device or the altitude information of the control device.

TABLE 2

| Equipment | |
|---|---|
| information of | |
| UAV (Equipment | |
| type of UAV) | Identity Information Set |
| UAV with function of | equipment identifier of UAV, location |
| remotely reporting | information of UAV, altitude information of |
| identity information | UAV, movement speed of UAV, time stamp of |
| | UAV, emergency state occurred at UAV, |
| | location information of control device or |
| | altitude information of control device |
| UAV reporting identity | equipment identifier of UAV, real-time |
| information through | location of UAV, real-time altitude |
| remote reporting module | information of UAV, movement speed of |
| not belonging | UAV, take-off position of UAV, altitude |
| to UAV | information when UAV takes off, or time |
| | stamp of UAV |

Optionally, in the case of Example 1, the first information may be the following types of information.

As to Type a, the first information includes information identifier of each identity information type in the at least one type of identity information.

For any one of the at least one type of identity information, the information identifier of the identity information includes one or more of the following: a category of the identity information, a name of the identity information, a serial number of the identity information, or the like.

As to Type b, the first information includes first identification information, and the first identification information is indicative of the at least one type of identity information.

Optionally, the operation of the base station obtaining the first information is that, based on the first identity information set, the base station obtains, from a correspondence between identity information sets and identification information, corresponding identification information as the first identification information.

For example, the first identity information set includes the above 8 types of identity information, and the base station stores a correspondence between the identity information sets and the identification information shown in Table 1 above. Based on the first identity information set, the base station obtains, from the correspondence between the identity information sets and the identification information shown in Table 1, the corresponding identification information “1” as the first identification information.

As to Type c, the first information includes a plurality of bits, with each identity information type in the at least one type of identity information in the first information corresponding to different bits, and a bit value corresponding to each identity information type is a first value.

Optionally, the base station obtains a first bit map, where the number of bits included in the first bit map is greater than or equal to the number of identity information types in the first identity information set, with each bit in the first bit map corresponding to one type of identity information and identity information types corresponding to respective bits are different. The base station determines at least one bit in the first bit map corresponding to the at least one type of identity information in the first identity information set, and obtains the first information by setting the value of the at least one bit to the first value, and setting the value of each bit except the at least one bit in the first bit map to a second value.

For example, referring to FIG. 4, the base station obtains the first bit map including twelve bits. In the first bit map, the identity information corresponding to the first bit is the equipment identifier of the UAV, the identity information corresponding to the second bit is the location information of the UAV, the identity information corresponding to the third bit is the altitude information of the UAV, the identity information corresponding to the fourth bit is the movement speed of the UAV, the identity information corresponding to the fifth bit is the time stamp of the UAV, the identity information corresponding to the sixth bit is the emergency state occurred at the UAV, the identity information corresponding to the seventh bit is the location information of the control device, the identity information corresponding to the eighth bit is the altitude information of the control device, the identity information corresponding to the ninth bit is the real-time location of the UAV, the identity information corresponding to the tenth bit is the real-time altitude information of the UAV, the identity information corresponding to the eleventh bit is the take-off position of the UAV, and the identity information corresponding to the twelfth bit is the altitude information of the UAV when it takes off.

Assuming that the first identity information set includes the above 8 types of identity information, the base station determines 8 bits corresponding to the 8 types of identity information in the first bit map, which are respectively the first bit, the second bit, the third bit, the fourth bit, the fifth bit, the sixth bit, the seventh bit and the eighth bit in the first bit map. In the first bit map, the values of the first bit, the second bit, the third bit, the fourth bit, the fifth bit, the sixth bit, the seventh bit and the eighth bit are all set to the first value “1”, and the values of the ninth bit, the tenth bit, the eleventh bit and the twelfth bit are all set to the second value “0”. The first information as shown in FIG. 4 is thus obtained.

Optionally, the at least one type of identity information includes first identity information, and the first information is used for configuring a sending manner of the UAV to send the first identity information, and/or the first information is used for configuring a sending condition of the UAV to send the first identity information.

Optionally, the base station may store a correspondence between the identity information and sending manners. Based on the first identity information, the base station obtains the sending manner of the first identity information from the correspondence between the identity information and the sending manners. The first information includes a correspondence between the first information and the sending manner of the first identity information.

Optionally, the base station may store a correspondence between the identity information and sending conditions. Based on the first identity information, the base station obtains the sending condition of the first identity information from the correspondence between the identity information and the sending conditions. The first information includes a correspondence between the first information and the sending condition of the first identity information.

Optionally, the sending manner of the first identity information includes a broadcast manner of the first identity information.

Optionally, the broadcast manner may be periodic broadcast or real-time broadcast. For example, when the first identity information is the equipment identifier of the UAV, the sending manner of the first identity information may include periodically broadcasting the equipment identifier of the UAV. For another example, the first identity information is the location information of the UAV, and the sending manner of the first identity information may include broadcasting the location information of the UAV in real time.

In Example 2, the first information is used for configuring a take-off condition(s) for the UAV to take off.

Optionally, the take-off condition includes an area in which the UAV can take off, and/or a time period in which the UAV can take off, and the like.

For example, the first information includes area information of the area in which the UAV can take off, and/or time information of the time period in which the UAV can take off. The area information may be an area name, an area number, or the like. The time information may be the starting time and ending time of the time period, or the starting time and duration of the time period, or the ending time and duration of the time period.

Optionally, when the equipment type of the UAV is a UAV that cannot remotely report identity information, the first information obtained by the base station is used for configuring the take-off condition(s) of the UAV.

Optionally, the take-off condition includes an area where the UAV can take off. Since the UAV cannot report identity information remotely, the UAV can take off in this area without reporting the identity information of the UAV remotely. The area is an area where the UAV is allowed to take off.

Optionally, the above take-off condition(s) may be configured in the UAV in advance.

In step 603, the first information is sent to the UAV.

Optionally, in step 603, the base station sends a second signaling to the UAV, where the second signaling includes a second IE, and the second IE includes the first information.

Optionally, the second signaling includes a second RRC signaling, and the second IE includes OtherConfig in the second RRC signaling. In other words, the base station sends the second RRC signaling to the UAV, and OtherConfig in the second RRC signaling includes the first information.

Optionally, the second signaling includes an RRC Reconfiguration signaling, an RRC Connection Reconfiguration signaling, or the like.

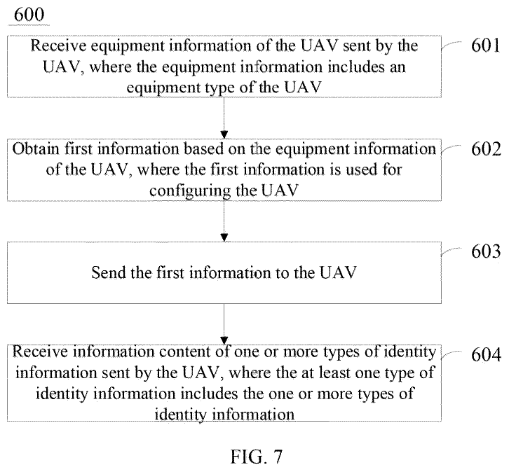

Optionally, referring to FIG. 7, after sending the first information, the base station may further perform the following operation of step 604: receiving information content of one or more types of identity information sent by the UAV, where the at least one type of identity information includes the one or more types of identity information.

Optionally, the base station may also send the information content of the one or more types of identity information to the control device. The control device receives the information content of the one or more types of identity information, and controls and/or manages the UAV based on the information content of the one or more types of identity information. For example, it controls the UAV to avoid obstacles, control the steering of the UAV, and the like.

To sum up, based on the method for configuring a UAV according to some embodiments of this disclosure, the base station receives the equipment information of the UAV sent by the UAV; then obtains the first information for configuring the UAV based on the equipment information, and sends the first information to the UAV, where the first information is used for configuring at least one type of identity information that the UAV is to send. In this way, the problem of causing the UAV to report corresponding identity information based on the equipment information of the UAV can be solved. The first information is used for configuring the sending manner and/or sending condition of the identity information, thereby solving the problem that the UAV can send the identity information according to the requirements of the base station. The first information is used for configuring the take-off condition for the UAV to take off, thereby solving the problem that the UAV can take off according to the requirements of the base station, Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

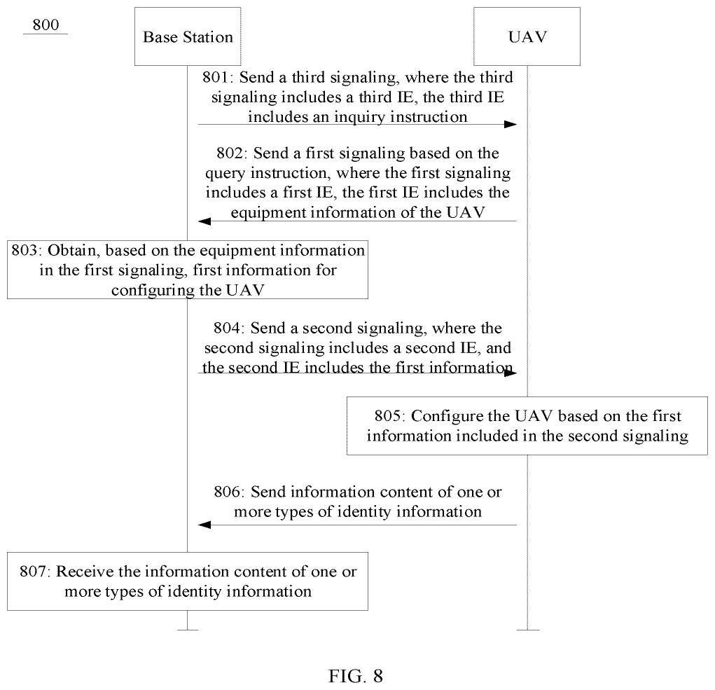

FIG. 8 shows a flow chart of a method 800 for configuring a UAV according to an exemplary embodiment of this disclosure. The method 800 is applied in the communication system 100 shown in FIG. 1 or FIG. 2 and achieved through the interaction between the UAV and the base station. The method 800 includes the followings.

In step 801, the base station sends a third signaling to the UAV, where the third signaling includes a third IE, the third IE includes an inquiry instruction, and the inquiry instruction is used for instructing the UAV to send the equipment information of the UAV.

In step 802, the UAV sends a first signaling to the base station based on the query instruction, where the first signaling includes a first IE, the first IE includes the equipment information of the UAV, and the equipment information includes the equipment type of the UAV.

The forgoing step 801 is an optional step. In other words, step 802 may be directly performed without performing step 801, In this way, in step 802, the UAV directly sends the first signaling including the equipment information of the UAV to the base station.

In step 803, the base station receives the first signaling sent by the UAV, and obtains, based on the equipment information in the first signaling, first information for configuring the UAV.

Optionally, the first information is used for configuring the UAV. Exemplarily, two examples in which the first information is used for configuring the UAV are listed below.

In Example 1, the first information is used for configuring at least one type of identity information that the UAV is to send.

In Example 1, the base station determines, based on the equipment information of the UAV, at least one type of identity information that the UAV is to send, and obtains the first information for configuring the at least one type of identity information.

Optionally, the operation of the base station determining the at least one type of identity information may be that, based on the equipment information of the UAV, the base station obtains a corresponding identity information set from the correspondence between the equipment information of UAV and the identity information sets, where the corresponding identity information set includes the at least one type of identity information that the UAV is to send.

Optionally, in the case of Example 1, the first information may be the following types of information.

As to Type a, the first information includes information identifier of each identity information type in the at least one type of identity information.

As to Type b, the first information includes first identification information, and the first identification information is indicative of the at least one type of identity information.

Optionally, the operation of the base station obtaining the first information is that, based on the first identity information set including the at least one type of identity information, the base station obtains, from a correspondence between identity information sets and identification information, corresponding identification information as the first identification information.

As to Type c, the first information includes a plurality of bits, with each identity information type in the at least one type of identity information in the first information corresponding to different bits, and a bit value corresponding to each identity information type is a first value.

Optionally, the at least one type of identity information includes first identity information, and the first information is used for configuring a sending manner of the UAV to send the first identity information, and/or the first information is used for configuring a sending condition of the UAV to send the first identity information.

In Example 2, the first information is used for configuring a take-off condition(s) for the UAV to take off.

Optionally, the take-off condition includes an area in which the UAV can take off, and/or a time period in which the UAV can take off, and the like.

Optionally, when the equipment type of the UAV is a UAV that cannot remotely report identity information, the first information obtained by the base station is used for configuring the take-off condition(s) of the UAV.

Optionally, the take-off condition includes an area where the UAV can take off. Since the UAV cannot report identity information remotely, the UAV can take off in this area without reporting the identity information of the UAV remotely. The area is an area where the UAV is allowed to take off.

Optionally, the above take-off condition(s) may be configured in the UAV in advance.

In step 804, the base station sends a second signaling to the UAV, where the second signaling includes a second IE, and the second IE includes the first information.

In step 805, the UAV receives the second signaling, and configures the UAV based on the first information included in the second signaling.

Optionally, the first information is used for configuring the UAV. Exemplarily, several examples in which the first information is used for configuring the UAV are listed below, including Example 1, Example 2 and Example 3 as follows respectively.

In Example 1, the first information is used for configuring at least one type of identity information that the UAV is to send. The UAV determines the at least one type of identity information that is to be sent based on the first information.

Optionally, in the case of Example 1, the first information may be the following types of information.

As to Type a, the first information includes information identifier of each identity information type in the at least one type of identity information. The UAV determines the at least one type of identity information based on the information identifier of the at least one type of identity information included in the first information.

As to Type b, the first information includes first identification information, and the first identification information is indicative of the at least one type of identity information. Based on the first identification information, the UAV obtains, from a correspondence between identity information sets and identification information, a corresponding first identity information set including the at least one type of identity information.

As to Type e, the first information includes a plurality of bits, and the value of bit corresponding to each identity information type in the at least one type of identity information in the first information is the first value. The UAV identifies at least one bit whose value is the first value in the first information, and determines the at least one type of identity information corresponding to the at least one bit.

Optionally, the at least one type of identity information includes first identity information, and the first information is used for configuring a sending manner of the UAV to send the first identity information, and/or the first information is used for configuring a sending condition of the UAV to send the first identity information. The UAV determines, based on the first information, a sending manner for the UAV to send the first identity information, and/or a sending condition for the UAV to send the first identity information.

In Example 2, the first information is used for configuring a take-off condition(s) for the UAV to take off.

Optionally, the UAV determines take-off conditions under which the UAV can take off based on the first information.

Optionally, the take-off condition includes an area in which the UAV can take off; and/or a time period in which the UAV can take off; and the like. In this way, the UAV takes off when the take-off condition is met. For example, the UAV starts to take off only when the UAV is in the area where the UAV can take off. Alternatively, for another example, the UAV only starts to take off when the current time is within the time period in which it can take off.

In the case where the first information is used for configuring at least one type of identity information that the UAV is to send, and configuring the sending manner and/or sending condition of the identity information, the UAV may further perform the following step 806.

In step 806, the UAV sends information content of one or more types of identity information to the base station, where the at least one type of identity information includes the one or more types of identity information.

In step 806, the UAV obtains the information content of the one or more types of identity information, and sends the information content of the one or more types of identity information to the base station based on the sending manner of the one or more types of identity information; or, sends the information content of the one or more types of identity information to the base station when the sending condition of the one or more types of identity information is met.

In step 807, the base station receives the information content of the one or more types of identity information.

Optionally, the base station may further send the information content of the one or more types of identity information to the control device. The control device receives the information content of the one or more types of identity information, and controls and/or manages the UAV based on the information content of the one or more types of identity information.

The above steps 806 and 807 are optional steps, that is, step 806 and step 807 may not be performed.

To sum up, based on the method for configuring a UAV according to some embodiments of this disclosure, the UAV sends the equipment information of the UAV to the base station; then the base station receives the equipment information of the UAV including the equipment type thereof, obtains the first information based on the equipment information, and sends the first information to the UAV, where the first information is used for configuring at least one type of identity information that the UAV is to send. In this way, the problem of causing the UAV to report corresponding identity information based on the equipment information of the UAV can be solved. The first information is used for configuring the sending manner and/or sending condition of the identity information, thereby solving the problem that the UAV can send the identity information according to the requirements of the base station. The first information is used for configuring the take-off condition for the UAV to take off, thereby solving the problem that the UAV can take off according to the requirements of the base station. Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

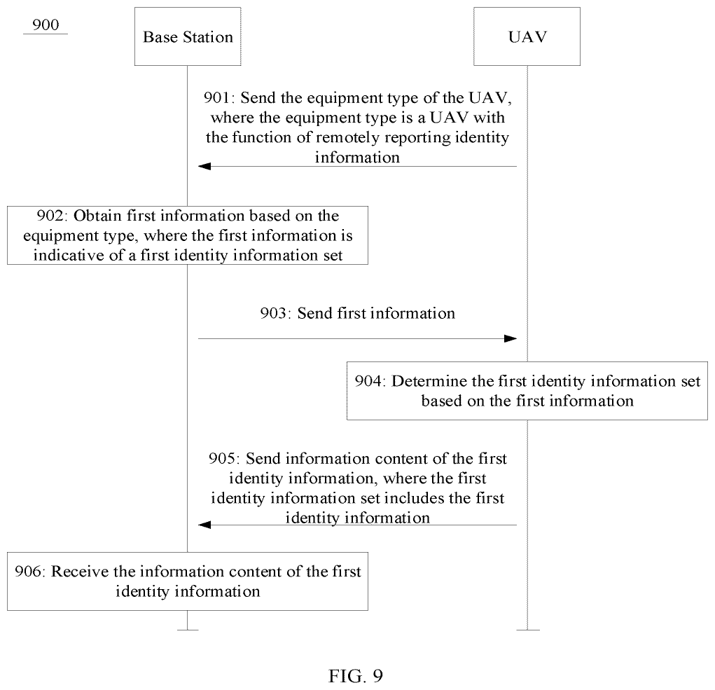

FIG. 9 shows a flow chart of a method 900 for configuring a UAV according to an exemplary embodiment of this disclosure. The method 900 is applied in the communication system 100 shown in FIG. 1 or FIG. 2 and achieved through the interaction between the UAV and the base station. The method 900 includes the followings.

In step 901, the UAV sends the equipment type of the UAV to the base station, where the equipment type is a UAV with the function of remotely reporting identity information.

Optionally, the UAV sends a first signaling to the base station, where the first signaling includes a first IE, the first IE includes the equipment type of the UAV, and the equipment type is a UAV with the function of remotely reporting identity information.

In step 902, the base station receives the equipment type and obtains first information based on the equipment type, where the first information is indicative of a first identity information set, and the first identity information set includes at least one type of identity information that the UAV is to send.

Based on the equipment type of the UAV (a UAV with the function of remotely reporting identity information), the base station obtains a first identity information set from the correspondence between equipment types of UAV and identity information sets. The first identity information set includes at least one type of identity information that the UAV is to send. The base station obtains the first information used for configuring the first identity information set.

For example, the base station stores the correspondence between the equipment types of UAV and the identity information sets as shown in Table 2 above. Based on the received equipment type of the UAV (a UAV with the function of remotely reporting identity information), the base station obtains the corresponding first identity information set from the correspondence between the equipment information of UAV and the identity information sets shown in Table 2 above. The first identity information set includes 8 types of identity information that the UAV is to send, which are respectively the equipment identifier of the UAV, the location information of the UAV, the altitude information of the UAV, the movement speed of the UAV, the time stamp of the UAV, the emergency state occurred at the UAV, the location information of the control device, and the altitude information of the control device.

Then the base station obtains the first information used for configuring the 8 types of identity information. The first information may be the following types of information.

As to Type a1, the first information includes information identifiers of each of the 8 types of identity information.

For example, it is assumed that the information identifier of the equipment identifier of the UAV is “11”, the information identifier of the location information of the UAV is “12”, the information identifier of the altitude information of the UAV is “13”, the information identifier of the movement speed of the UAV is “14”, the information identifier of the time stamp of the UAV is “15”, the information identifier of the emergency state occurred at the UAV is “16”, the information identifier of the location information of the control device is “17”, and the information identifier of the altitude information of the control device is “18”. The first information obtained by the base station for configuring the & types of identity information includes “11”, “12”, “13”, “14”, “15”, “16”, “17” and “18”.

As to Type b1, the first information includes first identification information “I”, and the first identification information “I” is indicative of the & types of identity information.

The correspondence between the identity information sets and the identification information shown in Table 1 above is stored in the base station. Based on the first identity information set including the 8 types of identity information, the base station obtains, from the correspondence between the identity information sets and the identification information shown in Table 1 above, the corresponding identification information “1” as the first identification information.

As to Type c1, the first information includes a plurality of bits, with each identity information type in the 8 types of identity information in the first information corresponding to a different bit, and a bit value corresponding to each identity information type is a first value.

For example, referring to FIG. 4, the base station obtains the first bit map including twelve bits. In the first bit map, the identity information corresponding to the first bit is the equipment identifier of the UAV, the identity information corresponding to the second bit is the location information of the UAV, the identity information corresponding to the third bit is the altitude information of the UAV, the identity information corresponding to the fourth bit is the movement speed of the UAV, the identity information corresponding to the fifth bit is the time stamp of the UAV, the identity information corresponding to the sixth bit is the emergency state occurred at the UAV, the identity information corresponding to the seventh bit is the location information of the control device, the identity information corresponding to the eighth bit is the altitude information of the control device, the identity information corresponding to the ninth bit is the real-time location of the UAV, the identity information corresponding to the tenth bit is the real-time altitude information of the UAV, the identity information corresponding to the eleventh bit is the take-off position of the UAV, and the identity information corresponding to the twelfth bit is the altitude information of the UAV when it takes off.

The first identity information set includes the above 8 types of identity information, the base station determines 8 bits corresponding to the 8 types of identity information in the first bit map, which are respectively the first bit, the second bit, the third bit, the fourth bit, the fifth bit, the sixth bit, the seventh bit and the eighth bit in the first bit map. In the first bit map, the values of the first bit, the second bit, the third bit, the fourth bit, the fifth bit, the sixth bit, the seventh bit and the eighth bit are all set to the first value “1”, and the values of the ninth bit, the tenth bit, the eleventh bit and the twelfth bit are all set to the second value “o”. The first information as shown in FIG. 4 is thus obtained.

In step 903, the base station sends the first information to the UAV.

Optionally, the base station sends a second signaling to the UAV, where the second signaling includes a second IE, and the second IE includes the first information.

In step 904, the UAV receives the first information and determines the first identity information set based on the first information.

For example, the first identity information set is a set including the above 8 types of identity information. Next, the process of determining the first identity information set for different first information is described.

Optionally, the first information includes information identifiers “11”, “12”, “13”, “14”, “15”, “16”, “17” and “18”. The UAV determines that the identity information corresponding to the information identifier “11” is the equipment identifier of the UAV, the identity information corresponding to the information identifier “12” is the location information of the UAV, the identity information corresponding to the information identifier “13” is the altitude information of the UAV, the identity information corresponding to the information identifier “14” is the movement speed of the UAV, the identity information corresponding to the information identifier “15” is the time stamp of the UAV, the identity information corresponding to the information identifier “16” is the emergency state occurred at the UAV, the identity information corresponding to the information identifier “17” is the location information of the control device, and the identity information corresponding to the information identifier “18” is the altitude information of the control device. In other words, the first identity information set as determined includes the equipment identifier of the UAV, the location information of the UAV, the altitude information of the UAV, the movement speed of the UAV, the time stamp of the UAV, the emergency state occurred at the UAV, the location information of the control device, and the altitude information of the control device.

Optionally, the first information includes first identification information “1”. The UAV stores the correspondence between the identity information sets and the identification information shown in Table 1 above. Based on the first identification information “I”, the UAV obtains the corresponding first identity information set from the correspondence between the identity information sets and the identification information as shown in Table I. The first identity information set includes the equipment identifier of the UAV, the location information of the UAV, the altitude information of the UAV, the movement speed of the UAV, the time stamp of the UAV, the emergency state occurred at the UAV, and the location information of the control device or the altitude information of the control device.

Optionally, the first information is the information shown in FIG. 4. The UAV identifies the first bit, the second bit, the third bit, the fourth bit, the fifth bit, the sixth bit, the seventh bit and the eighth bit whose value is the first value “1” from the first information as shown in FIG. 4. Based on the eight bits, eight types of identity information corresponding to the eight bits are determined. The eight types of identity information are respectively the equipment identifier of the UAV, the location information of the UAV, the altitude information of the UAV, the movement speed of the UAV, the time stamp of the UAV, the emergency state occurred at the UAV, the location information of the control device, and the altitude information of the control device. That is, the first identity information set is obtained.

In step 905, the UAV sends information content of the first identity information to the base station, where the first identity information set includes the first identity information.

For any identity information in the first identity information set, the identity information is called the first identity information for the convenience of description. When the UAV obtains the information content of the first identity information, the UAV sends the information content of first identity information to the base station.

In step 906, the base station receives the information content of the first identity information.

Optionally, the base station may further send the information content of the first identity information to the control device. The control device receives the information content of the first identity information, and controls and/or manages the UAV based on the information content of the first identity information. For example, the UAV is controlled to avoid obstacles, the steering of the UAV is controlled, and the like.

To sum up, based on the method for configuring a UAV according to some embodiments of this disclosure, the UAV sends the equipment type of the UAV to the base station, where the equipment type is a UAV with the function of remotely reporting identity information. The base station obtains the first information based on the equipment type and sends the first information to the UAV. The first information is used for configuring the first identity information set that the UAV is to send. The first identity information set includes at least one type of identity information. In this way, the problem of causing the UAV to report corresponding identity information based on the equipment type of the UAV can be solved. Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

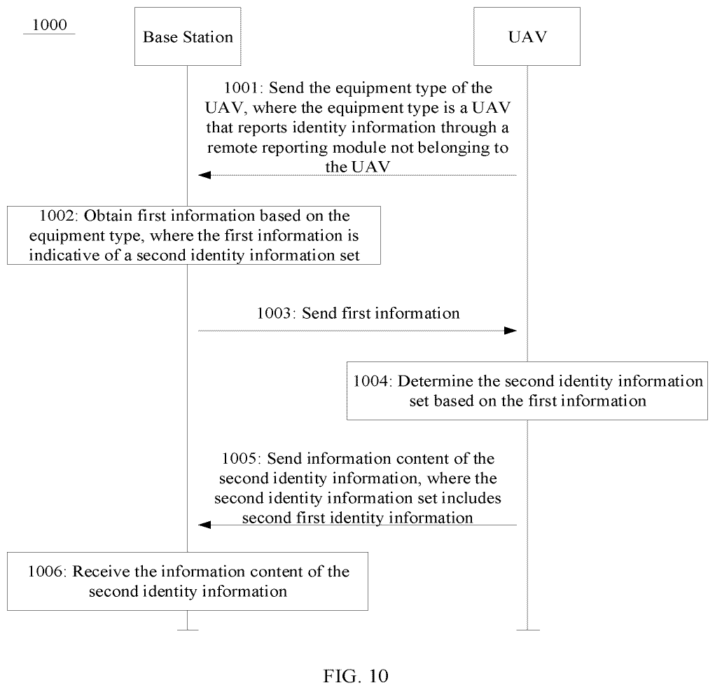

FIG. 10 shows a flow chart of a method 1000 for configuring a UAV according to an exemplary embodiment of this disclosure. The method 1000 is applied in the communication system 100 shown in FIG. 1 or FIG. 2 and achieved through the interaction between the UAV and the base station. The method 1000 includes the followings.

In step 1001, the UAV sends the equipment type of the UAV to the base station, where the equipment type is a UAV that reports identity information through a remote reporting module not belonging to the UAV.

Optionally, the UAV sends a first signaling to the base station, where the first signaling includes a first IE, the first IE includes the equipment type of the UAV, and the equipment type is a UAV that reports identity information through a remote reporting module not belonging to the UAV.

In step 1002, the base station receives the equipment type and obtains first information based on the equipment type, where the first information is indicative of a second identity information set, and the second identity information set includes at least one type of identity information that the UAV is to send.

Based on the equipment type of the UAV (a UAV that reports identity information through a remote reporting module not belonging to the UAV), the base station obtains a second identity information set from the correspondence between equipment types of UAV and identity information sets. The second identity information set includes at least one type of identity information that the UAV is to send. The base station obtains the first information used for configuring the second identity information set.

For example, the base station stores the correspondence between the equipment types of UAV and the identity information sets as shown in Table 2 above. Based on the received equipment type of the UAV (a UAV that reports identity information through a remote reporting module not belonging to the UAV), the base station obtains the corresponding second identity information set from the correspondence between the equipment information of UAV and the identity information sets shown in Table 2 above. The second identity information set includes 7 types of identity information that the UAV is to send, which are respectively the equipment identifier of the UAV, the real-time location of the UAV, the real-time altitude information of the UAV, the movement speed of the UAV, the take-off position of the UAV, the altitude information when the UAV takes off, and the time stamp of the UAV.

Then the base station obtains the first information used for configuring the 7 types of identity information. The first information may be the following types of information.

As to Type a2, the first information includes information identifiers of each of the 7 types of identity information.

For example, it is assumed that the information identifier of the equipment identifier of the UAV is “11”, the information identifier of the real-time location of the UAV is “19”, the information identifier of the real-time altitude information of the UAV is “20”, the information identifier of the movement speed of the UAV is “14”, the information identifier of the take-off position of the UAV is “21”, the information identifier of the altitude information when the UAV takes off is “22”, the information identifier of the time stamp of the UAV is “15”. The first information obtained by the base station for configuring the 7 types of identity information includes “11”, “19”, “20”, “14”, “21”, “22” and “15”

As to Type b2, the first information includes first identification information “2” and the first identification information “2” is indicative of the 7 types of identity information.

The correspondence between the identity information sets and the identification information shown in Table 1 above is stored in the base station. Based on the second identity information set including the 7 types of identity information, the base station obtains, from the correspondence between the identity information sets and the identification information shown in Table 1 above, the corresponding identification information “2” as the first identification information.

As to Type c2, the first information includes a plurality of bits, with each identity information type in the 7 types of identity information in the first information corresponding to a different bit, and a bit value corresponding to each identity information type is a first value.

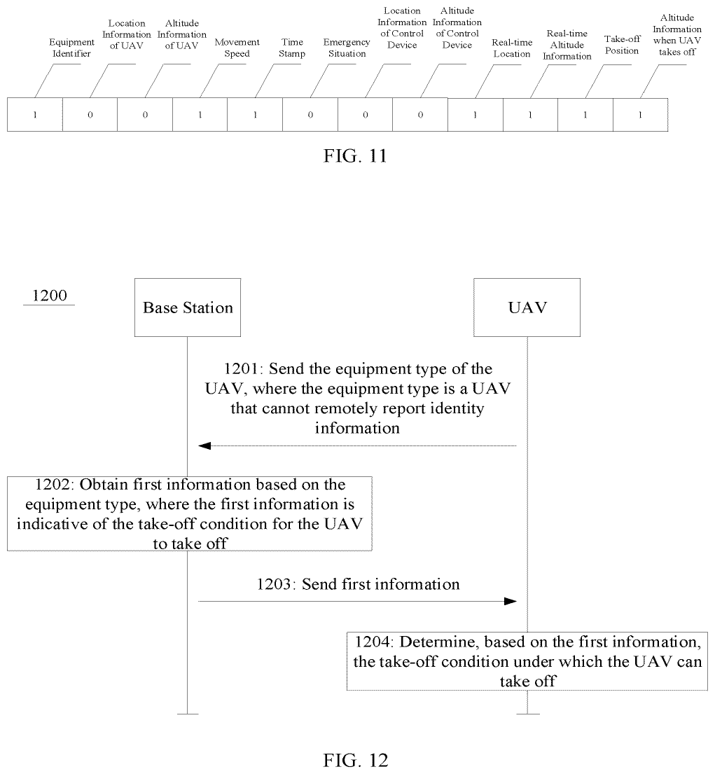

For example, referring to FIG. 11, the base station obtains a second bit map including twelve bits. In the second bit map, the identity information corresponding to the first bit is the equipment identifier of the UAV, the identity information corresponding to the second bit is the location information of the UAV, the identity information corresponding to the third bit is the altitude information of the UAV, the identity information corresponding to the fourth bit is the movement speed of the UAV, the identity information corresponding to the fifth bit is the time stamp of the UAV, the identity information corresponding to the sixth bit is the emergency state occurred at the UAV, the identity information corresponding to the seventh bit is the location information of the control device, the identity information corresponding to the eighth bit is the altitude information of the control device, the identity information, corresponding to the ninth bit is the real-time location of the UAV, the identity information corresponding to the tenth bit is the real-time altitude information of the UAV, the identity information corresponding to the eleventh bit is the take-off position of the UAV, and the identity information corresponding to the twelfth bit is the altitude information of the UAV when it takes off.

The second identity information set includes the above-mentioned 7 types of identity information. The base station determines the 7 bits corresponding to the 7 types of identity information in the second bitmap, which are respectively the first bit, the fourth bit, the fifth bit, the ninth bit, the tenth bit, the eleventh bit, and the twelfth bit in the second bitmap. In the second bitmap, the values of the first bit, the fourth bit, the fifth bit, the ninth bit, the tenth bit, the eleventh bit and the twelfth bit are all set to the first value “1”, and the values of the second bit, the third bit, the sixth bit, the seventh bit and the eighth bit are all set to the second value “0”. The first information as shown in FIG. 11 is thus obtained.

In step 1003, the base station sends the first information to the UAV.

Optionally, the base station sends a second signaling to the UAV, where the second signaling includes a second IE, and the second IE includes the first information.

In step 1004, the UAV receives the first information and determines the second identity information set based on the first information.

For example, the second identity information set is a set including the above 7 types of identity information. Next, the process of determining the second identity information set for different first information is described.

Optionally, the first information includes information identifiers “11”, “19”, “20”, “14”, “21”, “22” and “IS”. The UAV determines that the identity information corresponding to the information identifier “11” is the equipment identifier of the UAV, the identity information corresponding to the information identifier “19” is the real-time location of the UAV, the identity information corresponding to the information identifier “20” is the real-time altitude information of the UAV, the identity information corresponding to the information identifier “14” is the movement speed of the UAV, the identity information corresponding to the information identifier “21” is the take-off position of the UAV, the identity information corresponding to the information identifier “22” is the altitude information when the UAV takes off, and the identity information corresponding to the information identifier “15” is the time stamp of the UAV. In other words, the determined second identity information set includes the equipment identifier of the UAV, the real-time location of the UAV, the real-time altitude information of the UAV, the movement speed of the UAV, the take-off position of the UAV, the altitude information when the UAV takes off; and the time stamp of the UAV.

Optionally, the first information includes first identification information “2”. The UAV stores the correspondence between the identity information sets and the identification information shown in Table 1 above. Based on the first identification information “2”, the UAV obtains the corresponding second identity information set from the correspondence between the identity information sets and the identification information as shown in Table 1. The second identity information set includes the equipment identifier of the UAV, the real-time location of the UAV, the real-time altitude information of the UAV, the movement speed of the UAV, the take-off position of the UAV, the altitude information when the UAV takes off, and the time stamp of the UAV.

Optionally, the first information is the information shown in FIG. 11. The UAV identifies the first bit, the fourth bit, the fifth bit, the ninth bit, the tenth bit, the eleventh bit and the twelfth bit whose value is the first value “I” from the first information as shown in FIG. 11. Based on the 7 bits, seven types of identity information corresponding to the 7 bits are determined. The seven types of identity information are respectively the equipment identifier of the UAV, the real-time location of the UAV, the real-time altitude information of the UAV, the movement speed of the UAV, the take-off position of the UAV, the altitude information when the UAV takes off, and the time stamp of the UAV. That is, the second identity information set is obtained.

In step 1005, the UAV sends information content of the second identity information to the base station, where the second identity information set includes the second identity information.

For any identity information in the second identity information set, the identity information is called the second identity information for the convenience of description. When the UAV obtains the information content of the second identity information, the UAV sends the information content of second identity information to the base station.

In step 1006, the base station receives the information content of the second identity information.

Optionally, the base station may further send the information content of the second identity information to the control device. The control device receives the information content of the second identity information, and controls and/or manages the UAV based on the information content of the second identity information. For example, the UAV is controlled to avoid obstacles, the steering of the UAV is controlled, and the like.

To sum up, based on the method for configuring a UAV according to some embodiments of this disclosure, the UAV sends the equipment type of the UAV to the base station, where the equipment type is a UAV that reports identity information through a remote reporting module not belonging to the UAV. The base station obtains the first information based on the equipment type and sends the first information to the UAV. The first information is used for configuring the second identity information set that the UAV is to send. The second identity information set includes at least one type of identity information. In this way, the problem of causing the UAV to report corresponding identity information based on the equipment type of the UAV can be solved. Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

FIG. 12 shows a flow chart of a method 1200 for configuring a UAV according to an exemplary embodiment of this disclosure. The method 1200 is applied in the communication system 100 shown in FIG. 1 or FIG. 2 and achieved through the interaction between the UAV and the base station. The method 1200 includes the followings.

In step 1201, the UAV sends the equipment type of the UAV to the base station, where the equipment type is a UAV that cannot remotely report identity information.

Optionally, the UAV sends a first signaling to the base station, where the first signaling includes a first IE, the first IE includes the equipment type of the UAV, and the equipment type is a UAV that cannot remotely report identity information.

In step 1202, the base station receives the equipment type and obtains first information based on the equipment type, where the first information is indicative of the take-off condition for the UAV to take off.

Optionally, the base station receives the equipment type, determines that the equipment type is a UAV that cannot remotely report identity information, determines the takeoff condition under which the UAV can take off, and obtains the first information for configuring the UAV.

Optionally, the take-off condition includes an area in which the UAV can take off, and/or a time period in which the UAV can take off, and the like.

For example, the first information includes area information of the area in which the UAV can take off, and/or time information of the time period in which the UAV can take off.

In step 1203, the base station sends the first information to the UAV.

Optionally, the base station sends a second signaling to the UAV, where the second signaling includes a second IE, and the second IE includes the first information.

In step 1204, the UAV receives the first information and determines, based on the first information, the take-off condition under which the UAV can take off.

Optionally, the take-off condition includes the area in which the UAV can take off, and/or the time period in which the UAV can take off, and the like.

Optionally, the take-off condition includes the area where the UAV can take off. When the UAV receives a take-off command sent by the control device, if an area where the UAV is currently located is in the area indicated by the take-off condition, the UAV will take off; if the area where the UAV is currently located is not in the area indicated by the take-off condition, take-off will be rejected.

Optionally, the take-off condition includes the time period in which the UAV can take off. When the UAV receives a take-off command sent by the control device, if a current timepoint is within the time period indicated by the take-off condition, the UAV will take off; if the current timepoint is not within the time period indicated by the takeoff condition, take-off will be rejected.

To sum up, based on the method for configuring a UAV according to some embodiments of this disclosure, the UAV sends the equipment type of the UAV to the base station, where the equipment type is a UAV that cannot remotely report identity information. The base station receives the equipment type of the UAV, obtains the first information based on the equipment information, and sends the first information to the UAV. The first information is used for configuring the take-off condition for the UAV to take off. In this way, the problem that the UAV takes off according to the requirements of the base station can be solved. Because the base station and the UAV communicate with each other by using a cellular communication network, the UAV can be configured remotely and can remotely report identity information, thereby improving the efficiency and flexibility of configuring the UAV, and improving the efficiency and flexibility of reporting identity information by the UAV.

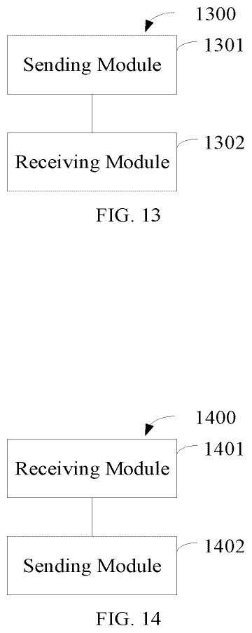

FIG. 13 shows a block diagram of an apparatus 1300 for configuring a UAV according to an exemplary embodiment of this disclosure. The apparatus 1300 is deployed on the UAV. The apparatus 1300 can be implemented as part or all of an UAV through software, hardware, or a combination thereof. The apparatus 1300 includes:
a sending module 1301, configured to send equipment information of the UAV to a base station, where the equipment information includes an equipment type of the UAV;
a receiving module 1302, configured to receive first information sent by the base station based on the equipment information, where the first information is used for configuring the UAV.

In some embodiments, the equipment type is a UAV with a function of remotely reporting identity information; a UAV reporting identity information through a remote reporting module, where the remote reporting module does not belong to the UAV; or a UAV that cannot report identity information remotely.

In some embodiments, the first information is used for configuring at least one type of identity information that the UAV is to send.

In some embodiments, the equipment type is a UAV with the function of remotely reporting identity information, and the at least one type of identity information includes at least one of the following:
an equipment identifier of the UAV;
location information of the UAV;
altitude information of the UAV;
a movement speed of the UAV;
a time stamp of the UAV;
an emergency situation occurred at the UAV;
location information of a control device or altitude information of the control device, wherein the control device is a device configured to control the UAV.

In some embodiments, the equipment type is a UAV that reports identity information through a remote reporting module that does not belong to the UAV, and the at least one type of identity information includes at least one of the following:
an equipment identifier of the UAV;
a real-time location of the UAV;
real-time altitude information of the UAV;
a movement speed of the UAV;
a take-off position of the UAV;
altitude information when the UAV takes off; or
a time stamp of the UAV.

In some embodiments, the first information includes an information identifier of each identity information type in the at least one type of identity information; or, the first information includes first identification information, and the first identification information is indicative of the at least one type of identity information; or, the first information includes at least one bit, and each identity information type in the at least one type of identity information corresponds to one bit in the first information.

In some embodiments, the equipment type is a UAV that cannot remotely report identity information, and the first information is used for configuring a takeoff condition under which the UAV can take off.

In some embodiments, the take-off condition includes an area in which the UAV can take off, and/or a time period in which the UAV can take off.

In some embodiments, the equipment information further includes at least one of the following:
an equipment group to which the UAV belongs; or
an application field where the UAV is applied.

In some embodiments, the sending module 1301 is configured to send a first signaling to the base station, where the first signaling includes a first IE, and the first IE includes the equipment information.

In some embodiments, the first signaling includes a first RRC signaling, and the first IE includes at least one of the following:
UE-BUTRA-Capability;
UE-MRDC-Capability; or
UE-NR-Capability.

In some embodiments, the receiving module 1302 is configured to receive a second signaling sent by the base station, where the second signaling includes a second IE, and the second IE includes the first information.

In some embodiments, the second signaling includes a second RRC signaling, and the second IE includes OtherConfig.

In some embodiments, the receiving module 1302 is further configured to receive an inquiry instruction sent by the base station, where the inquiry instruction is used for instructing the UAV to send the equipment information.

In some embodiments, the receiving module 1302 is configured to receive a third signaling sent by the base station, where the third signaling includes a third IE, and the third IE includes the inquiry instruction.

In some embodiments, the third signaling includes a third RRC signaling, and the third IE includes UECapabilityEnquiry.

To sum up, based on the apparatus for configuring a UAV according to some embodiments of this disclosure, the sending module sends the equipment information of the UAV to the base station, where the equipment information includes the equipment type of the UAV. The receiving module receives the first information sent by the base station based on the equipment information, where the first information is used for configuring the UAV. Since a cellular communication network is used for communication between the base station and the apparatus, the UAV can be configured remotely, thereby improving the efficiency and flexibility of configuring the UAV.

FIG. 14 shows a block diagram of an apparatus 1400 for configuring a UAV according to an exemplary embodiment of this disclosure. The apparatus 1400 can be implemented as part or all of a base station through software, hardware, or a combination thereof. The apparatus 1400 includes:
a receiving module 1401, configured to receive equipment information of the UAV, where the equipment information comprises an equipment type of the UAV;
a sending module 1402, configured to send first information to the UAV based on the equipment information, where the first information is used for configuring the UAV.

In some embodiments, the equipment type is a UAV with a function of remotely reporting identity information; a UAV reporting identity information through a remote reporting module, where the remote reporting module does not belong to the UAV; or a UAV that cannot report identity information remotely.

In some embodiments, the first information is used for configuring at least one type of identity information that the UAV is to send.

In some embodiments, the equipment type is a UAV with the function of remotely reporting identity information, and the at least one type of identity information includes at least one of the following:
an equipment identifier of the UAV;
location information of the UAV;
altitude information of the UAV;
a movement speed of the UAV;
a time stamp of the UAV;
an emergency situation occurred at the UAV;
location information of a control device or altitude information of the control device, wherein the control device is a device configured to control the UAV.

In some embodiments, the equipment type is a UAV that reports identity information through a remote reporting module that does not belong to the UAV, and the at least one type of identity information includes at least one of the following:
an equipment identifier of the UAV;
a real-time location of the UAV;
real-time altitude information of the UAV;
a movement speed of the UAV;
a take-off position of the UAV;
altitude information when the UAV takes off; or
a time stamp of the UAV.

In some embodiments, the first information includes an information identifier of each identity information type in the at least one type of identity information; or,
the first information includes first identification information, and the first identification information is indicative of the at least one type of identity information; or,
the first information includes at least one bit, and each identity information type in the at least one type of identity information corresponds to one bit in the first information.

In some embodiments, the equipment type is a UAV that cannot remotely report identity information, and the first information is used for configuring a takeoff condition under which the UAV can take off.

In some embodiments, the take-off condition includes an area in which the UAV can take off, and/or a time period in which the UAV can take off.

In some embodiments, the equipment information further includes at least one of the following:
an equipment group to which the UAV belongs; or
an application field where the UAV is applied.

In some embodiments, the receiving module 1401 is configured to receive a first signaling sent by the UAV, where the first signaling includes a first IE, and the first IE includes the equipment information.

In some embodiments, the first signaling includes a first RRC signaling, and the first IE includes at least one of the following:
UE-EUTRA-Capability;
UE-MRDC-Capability; or
UE-NR-Capability.

In some embodiments, the sending module 1402 is configured to send a second signaling to the UAV, where the second signaling includes a second IE, and the second IE includes the first information.

In some embodiments, the second signaling includes a second RRC signaling, and the second IE includes OtherConfig.

In some embodiments, the sending module 1402 is also configured to send an inquiry instruction to the UAV, where the inquiry instruction is used for instructing the UAV to send the equipment information.

In some embodiments, the sending module 1402 is configured to send a third signaling to the UAV, where the third signaling includes a third IE, and the third IE includes the inquiry instruction.

In some embodiments, the third signaling includes a third RRC signaling, and the third IE includes UECapability Enquiry.

To sum up, based on the apparatus for configuring a UAV according to some embodiments of this disclosure, the receiving module receives the equipment information of the UAV sent by the UAV, where the equipment information includes the equipment type of the UAV. The sending module sends first information to the UAV based on the equipment information, where the first information is used for configuring the UAV. Since a cellular communication network is used for communication between the base station and the apparatus, the UAV can be configured remotely, thereby improving the efficiency and flexibility of configuring the UAV.

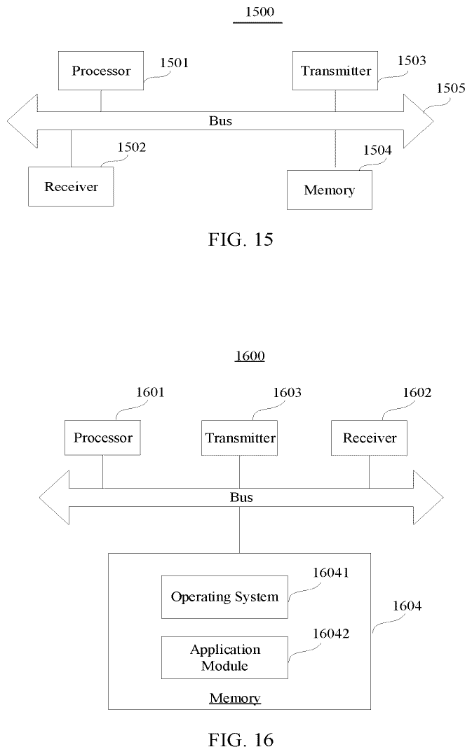

FIG. 15 shows a schematic structural diagram of a UAV 1500 according to an exemplary embodiment of this disclosure. The UAV 1500 includes: a processor 1501, a receiver 1502, a transmitter 1503, a memory 1504 and a bus 1505.

The processor 1501 includes one or more processing cores. The processor 1501 executes various functional applications and information processing by running software programs and modules.

The receiver 1502 and the transmitter 1503 can be implemented as a communication component, and the communication component can be a communication chip. The memory 1504 is connected to the processor 1501 through the bus 1505.

The memory 1504 may be configured to store at least one instruction, and the processor 1501 is configured to execute the at least one instruction to implement each step in the above method embodiment.

In addition, the memory 1504 may be implemented by any type of volatile or non-volatile storage device, or combination thereof, including but not limited to: magnetic or optical disks, electrically erasable programmable read-only memory (EEPROM), erasable programmable read-only memory (EPROM), static random-access memory (SRAM), read-only memory (ROM), magnetic memory, flash memory, programmable read-only memory (PROM).

In an exemplary embodiment, a non-transitory computer-readable storage medium including instructions, such as a memory including instructions, is further provided, and the instructions can be executed by a processor of UE to implement the above method for configuring UAV. For example, the non-transitory computer-readable storage medium may be ROM, random access memory (RAM), compact disc read-only memory (CD-ROM), magnetic tape, floppy disk, optical data storage device, and the like.

There is provided a non-transitory computer-readable storage medium, when the instructions in the non-transitory computer storage medium are executed by the processor of the UAV 1500, the UAV 1500 is enabled to perform the above method for configuring the UAV.

FIG. 16 is a block diagram of a base station 1600 according to an exemplary embodiment. The base station 1600 may include a processor 1601, a receiver 1602, a transmitter 1603, and a memory 1604. The receiver 1602, the transmitter 1603 and the memory 1604 are respectively connected to the processor 1601 through a bus.

The processor 1601 includes one or more processing cores, and the processor 1601 implements the method for configuring UAV according to some embodiments of this disclosure by running software programs and modules. The memory 1604 may be configured to store software programs and modules. Specifically, the memory 1604 may store an operating system 16041 and an application module 16042 required for at least one function. The receiver 1602 is configured to receive communication data sent by other devices, and the transmitter 1603 is configured to send communication data to other devices.

An exemplary embodiment of this disclosure further provides a computer-readable storage medium. The computer-readable storage medium stores at least one instruction, at least one program, a code set or an instruction set. The at least one instruction, the at least one program, the code set or the instruction set is loaded and executed by the processor to implement the method for configuring UAV according to each of the above method embodiments.

An exemplary embodiment of this disclosure further provides a computer program product, which includes computer instructions stored in a computer-readable storage medium. The processor of a computer device reads the computer instructions from the computer-readable storage medium, and executes the computer instructions, thereby causing the computer device to implement the method for configuring UAV according to each of the above method embodiments.

It should be understood that “plurality” mentioned in this article means two or more. The phrase “and/or” describes the relationship between related objects, indicating that there may be three relationships. For example, A and/or B may mean: A exists alone, both A and B exist, and B exists alone. The character “/” generally indicates that the related objects are in an “or” relationship.

It is further understood that the terms “first”, “second”, and the like are used to describe various information, but such information should not be limited to these terms. These terms are only used to distinguish information of the same type from each other and do not imply a specific order or importance. In fact, expressions such as “first” and “second” can be used interchangeably. For example, without departing from the scope of this disclosure, the first message frame may also be called a second message frame, and similarly, the second message frame may also be called a first message frame.

It will be further understood that although the operations are described in a specific order in the drawings in the embodiments of this disclosure, this should not be understood as requiring that these operations be performed in the specific order shown or in the serial order, or that all these described operations are required to be performed.

Other embodiments of the disclosure will be readily apparent to those skilled in the art from consideration of the specification and practice of the invention disclosed herein. This disclosure is intended to cover any variations, uses, or adaptations of the disclosure that follow the general principles of the disclosure and include common sense or customary technical means in the art that are not disclosed in the disclosure. It is intended that the specification and examples be considered as exemplary only, with a true scope and spirit of the disclosure being indicated by the following claims.

It is to be understood that this disclosure is not limited to the precise structures described above and illustrated in the accompanying drawings, and various modifications and changes may be made without departing from the scope thereof. The scope of the disclosure is limited only by the appended claims.

1. A method for configuring an unmanned aerial vehicle (UAV), characterized in being performed by the UAV and comprising:
sending equipment information of the UAV to a base station, wherein the equipment information comprises an equipment type of the UAV; and
receiving first information sent by the base station based on the equipment information, wherein the first information is used for configuring the UAV.

2. The method of claim 1, wherein the equipment type is one of:
a UAV with a function of remotely reporting identity information;
a UAV reporting identity information through a remote reporting module, wherein the remote reporting module does not belong to the UAV; or
a UAV that cannot report identity information remotely.

3. The method of claim 2, wherein the first information is used for configuring at least one type of identity information that the UAV is to send.

4. The method of claim 3, wherein the equipment type is the UAV with the function of remotely reporting identity information, and the at least one type of identity information comprises at least one of:
an equipment identifier of the UAV;
location information of the UAV;
altitude information of the UAV;
a movement speed of the UAV;
a time stamp of the UAV;
an emergency situation occurred at the UAV; or
location information of a control device or altitude information of the control device, wherein the control device is a device configured to control the UAV.

5. The method of claim 3, wherein the equipment type is the UAV reporting the identity information through the remote reporting module, and the at least one type of identity information comprises at least one of:
an equipment identifier of the UAV;
a real-time location of the UAV;
real-time altitude information of the UAV;
a movement speed of the UAV;
a take-off position of the UAV;
altitude information when the UAV takes off; or
a time stamp of the UAV.

6. The method of claim 3, wherein the first information comprises an information identifier of each identity information type in the at least one type of identity information; or,
the first information comprises first identification information, and the first identification information is indicative of the at least one type of identity information; or,
the first information comprises at least one bit, and each identity information type in the at least one type of identity information corresponds to one bit in the first information.

7. The method of claim 2, wherein the equipment type is the UAV that cannot report identity information remotely, and the first information is used for configuring a take-off condition.

8. The method of claim 7, wherein the take-off condition comprises at least one of an area where the UAV can take off, or a time period when the UAV can take off.

9. The method of claim 1, wherein the equipment information further comprises at least one of:
an equipment group to which the UAV belongs; or
an application field where the UAV is applied.

10-16. (canceled)

17. A method for configuring an unmanned aerial vehicle (UAV), characterized in being performed by a base station and comprising:
receiving equipment information of the UAV, wherein the equipment information comprises an equipment type of the UAV; and
sending first information to the UAV based on the equipment information, wherein the first information is used for configuring the UAV.

18-24. (canceled)

25. The method of claim 17, wherein the equipment information further comprises at least one of:
an equipment group to which the UAV belongs; or
an application field where the UAV is applied.

26. The method of claim 17, wherein receiving the equipment information of the UAV comprises:
receiving a first signaling sent by the UAV, wherein a first information element (IE) in the first signaling comprises the equipment information of the UAV.

27. The method of claim 26, wherein the first signaling comprises a first radio resource control (RRC) signaling, and the first IE comprises at least one of:
user equipment-evolved universal terrestrial radio access network-capability (UE-BUTRA-Capability);
user equipment-Multi-RAT dual connectivity-capability (UE-MRDC-Capability); or
user equipment-new radio-capability (UE-NR-Capability).

28. The method of claim 17, wherein sending the first information to the UAV comprises:
sending a second signaling to the UAV, wherein the second signaling comprises a second IE, and the second IE comprises the first information.

29. The method of claim 28, wherein the second signaling comprises a second RRC signaling, and the second IE comprises other configuration (OtherConfig).

30. The method of claim 17, further comprising:
sending an inquiry instruction to the UAV, wherein the inquiry instruction is used for instructing the UAV to send the equipment information.

31. The method of claim 30, wherein sending the inquiry instruction to the UAV comprises:
sending a third signaling to the UAV, wherein the third signaling comprises a third IE, and the third IE comprises the inquiry instruction.

32. The method of claim 31, wherein the third signaling comprises a third RRC signaling, and the third IE comprises user equipment capability enquiry (UECapabilityEnquiry).

33-34. (canceled)

35. An unmanned aerial vehicle (UAV), characterized in comprising:
a processor;
a memory storing instructions executable by the processor; and
a transceiver coupled to the processor,
wherein the processor is configured to:
send, through the transceiver equipment information of the UAV to a base station, wherein the equipment information comprises an equipment type of the UAV; and
receive, through the transceiver, first information sent by the base station based on the equipment information, wherein the first information is used for configuring the UAV.

36. A base station, characterized in comprising:
a processor;
a memory storing instructions executable by the processor; and
a transceiver coupled to the processor,
wherein the processor is configured to execute the method for configuring the UAV according to claim 17.

37-38. (canceled)
